(19) United States
(12) Patent Application Publication
(10) Pub. No.: US 2002/0019163 A1
(43) Pub. Date: Feb. 14, 2002

(54) Cable connector

(75) Inventor: Othmar Gaidosch, Ostfildern (DE)

Correspondence Address: Robert J. Koch, Fulbright & Jaworski, LLP, 801 Pennsylvania Avenue, N.W., Washington, DC, 20004, US

(73) Assignee: Hirschman Electronics GmbH & Co. KG, Stuttgarter Strasse (DE)

(21) Appl. No.: 09/864,859

(22) Filed: May 25, 2001

(30) Foreign Application Priority Data
May 26, 2000 (DE) 100 26 294.5

(51) Int. Cl. H01R 4/24

(52) U.S. Cl. 439/393

(57) ABSTRACT

A cable connector having a cable receiving part for holding at least one cable end and a contact part configured to secure the cable end in the cable receiving part such that it is mechanically pretensioned after connection. A clamping device may be associated with the receiving part, which may also include a tapered line chamber. The contact part may include an insulation piercing connecting device for securing the cable end, wherein the axial center line of the device may be parallel or not parallel with the axial center line of the line chamber.

### BACKGROUND OF THE INVENTION

1. Field of the Invention

The present invention relates to a cable connector. More particularly, the present invention relates to a multipin cable connector.

2. Description of the Related Technology

EP 0 684 666 B1 discloses a multipin cable connector. This cable connector has a cable receiving part into which individual flexible leads are inserted for making axial contact of their plug-side end sections with the cable-side end areas which are configured as contact spikes. Upon insertion, the contact spikes penetrate axially into the individual leads such that contact is made.

In studying a cable connector over an extended period, it has been found that the force in the contact area of the contact spike decreases with time so that after prolonged use of the cable connector; reliable contact-making is no longer ensured. Data transmission or power supply via such a cable connector is not always guaranteed. As will be appreciated by one of ordinary skill in the art, when data transmission or power supply fails, undesirable effects, especially in situations critical to safety, can occur.

### SUMMARY OF THE INVENTION

Therefore one object of the invention is to devise a cable connector of the aforementioned type for connection of single-core or multicore stranded cable of any configuration, in which permanently reliable contact-making is ensured.

This and other objects may be achieved by providing a cable connector having a cable receiving part for holding a cable end, wherein said cable end is mechanically pretensioned in said cable receiving part after connection by a contact-making means.

According to one aspect of the invention, the contact-making means comprises an insulation piercing connecting device which secures the cable end in the cable receiving part such that after connection it is mechanically pretensioned. Using an insulation piercing connecting device ensures that the cable end can be inserted into the cable receiving part quickly and easily, i.e. without major prior effort, which prevents stripping the insulation.

The insulation piercing connecting device during installation ensures that the outer insulation of the cable end may be split and electrical contact with the core of the cable is established. Because the insulation piercing connecting device fixes the cable end in the cable receiving part such that after electrical connection it is under stable mechanical pretension, permanently reliable contact-making is ensured since as a result of this pretensioning the cable end is always pressed in the direction of the insulation piercing connecting device or vice versa. As will be appreciated by one of ordinary skill in the art, this is of great importance when the core of the cable consists of copper leads since copper has the property of creeping.

The cable connector is preferably used for single-core cable, but of course may also be used for several individual cables and also for a single multipin cable. The structural shape of the cable connector (round, square or the like) is irrelevant.

According to one aspect of the invention, the cable receiving part has a line chamber which is larger in cross section than the cross section of the cable. The cable end is thus guided along the line chamber when inserted into the cable receiving part. At the same time, the cable end after fixing in the cable receiving part can move slightly when contact is made with the insulation piercing connecting device, resulting in mechanical pretensioning. In the penetration or contact-making area, especially in the X-Y plane, it is not necessary to route the cable end along a defined path. As will be appreciated by one of ordinary skill in the art, this provides for a simple configuration of the cable receiving part and its assembly. As will also be appreciated, another advantage lies in the use of cable ends with differing thicknesses.

According to another aspect of the invention, the cable receiving part has a clamping sleeve. This clamping sleeve can be inserted either after insertion of the cable end into the cable receiving part or inserted when the cable end is being inserted into the line chamber and can be penetrated by the cable end. After the cable end has been inserted into the line chamber, the clamping sleeve is attached (preferably mechanically) and fixes the position of the cable end with reference to the cable receiving part. Alternatively, before the cable end has been inserted, the clamping wedges can be made as barbs, which after insertion of the cable end, hold the latter. In this installation step, provisions can be made for the piece of the cable end which is located in the line chamber to be under mechanical pretension. This increases the effectiveness of contact-making since this mechanical pretensioning arises when contact is made with the insulation piercing connecting device. In addition, fixing the cable end by means of the clamping sleeve results in the cable end being unable to move out of the line chamber when contact is made with the insulation piercing connecting device. Instead of a clamping sleeve it is of course also conceivable for the cable to be fixed detachably or permanently in the line chamber, with the last piece of the cable remaining freely movable in the line chamber. With respect to permanent fixing, it is also possible to cement the cable in the top end of the line chamber. The use of a clamping sleeve, however, has the advantage that it can be both inserted mechanically and also fixed.

According to another aspect of the invention, the insulation piercing connecting device is located in a receiving means for insulation piercing connecting devices. The receiving means for the insulation piercing connecting devices can be connected to the cable receiving part. Thus, as described above, the cable end can be inserted into the cable receiving part and fixed. The insulation piercing connecting device may then penetrate into the lower area of the line chamber by feed of the receiving means for the insulation piercing connecting devices and cause contact to be made. Finally, the cable receiving part and the receiving means for the insulation piercing connecting devices may be connected to one another (for example, by clipping, screwing, welding, cementing or the like) to form a finished cable connector. The insulation piercing connecting device on its side facing away from the contact area has connection means, such as contact pins, contact tubes or the like. They can be exposed or can also be concentrically surrounded by part of the receiving means for the insulation piercing connecting devices.

According to another aspect of the invention, the line chamber tapers in its end area (contact area). This tapering results in a transverse arrangement of the cable end buckling direction, by which further alignment of the cable end to the spring direction of the insulation piercing connecting device is no longer necessary. Furthermore, due to this tapering (wedge-shaped configuration) of the line chamber it can be provided with cable ends (wires) of different diameters. For different diameters the tapering causes the cable end to be guided in the direction in which the cable end assumes a position in which it can be reliably penetrated by the insulation piercing connecting device.

According to another aspect of the invention, the line chamber has a diamond-shaped cross section. This configuration of the cross section of the line section ensures that the cable end has enough room for slightly curved deformation, and that centering takes place which ensures that upon making contact with the insulation piercing connecting device the cable end cannot recede such that contact is not made.

According to yet another aspect of the invention, the center lines of the insulation piercing connecting device and the line chamber are flush, parallel or tilted to one another. The almost axial or ideally axial penetration of the insulation of the cable end yields a large-area, highly redundant, permanently elastic and gas-tight electrical connection between the insulation piercing connecting device and the conductive core of the cable end.

### BRIEF DESCRIPTION OF THE DRAWINGS

One embodiment of the cable connector according to the invention, to which however the invention is not limited, is described below and explained using the figures, wherein:

FIG. 1 shows a cable connector in a lengthwise section and

FIG. 2 shows a cable connector in cross section.

### DETAILED DESCRIPTION

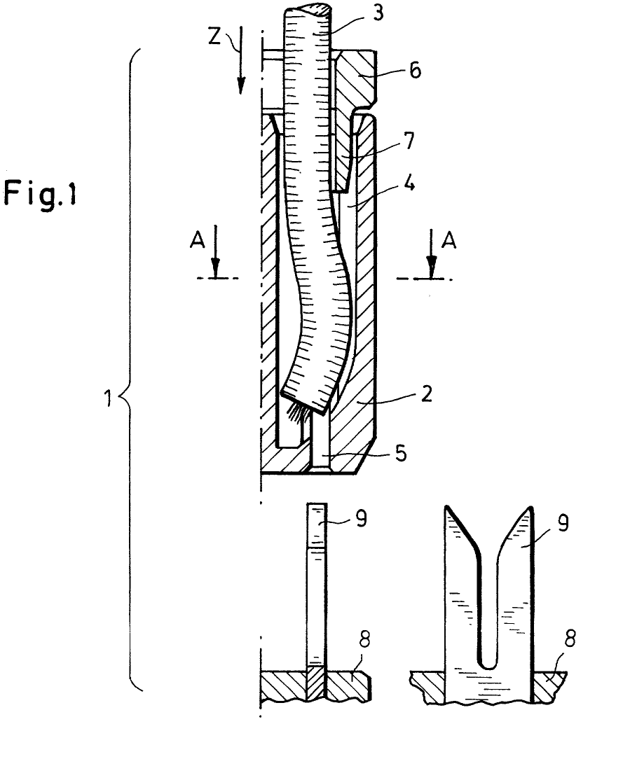

FIG. 1 shows a cable connector 1 with a cable receiving part 2 into which one cable end 3 can be inserted. For this purpose, in the cable receiving part 2 there is a line chamber 4 with a cross section (especially a diameter) which is slightly larger than the diameter of the cable end 3. In the lower area of the cable receiving part 2 there is an opening 5 (slit) through which an insulation piercing connecting device yet to be described can be inserted into the line chamber 4. In the top area of the cable receiving part 2 there is a clamping sleeve 6 which has a clamping wedge 7 which extends in the axial direction (Z direction). The clamping wedge has an extension such that it at least partially fills the remaining space of the cross section of the line chamber 4 which is not filled by the cable end 3 and in addition can exert sufficient pressure on the cable end 3.

The cable connector 1 shown in FIG. 1 is assembled as follows.

The cable end 3 is threaded through the clamping sleeve 6 in the Z-direction and is inserted into the line chamber 4 of the cable receiving part 2. The clamping sleeve 6 is then likewise brought together with the top collar of the cable receiving part 2 and locked such that the clamping wedge 7 prevents the cable end 3 from receding. The wedge-shaped tapering of the line chamber 4 in the Z direction causes the tip of the cable end 3 with respect to the insulation piercing connecting device to assume a defined position or the accordingly cropped cable end 3 to buckle slightly at least once in the X direction, i.e. the cable end 3 to assume a slightly curved or also S shape. An insulation piercing connecting device 9 which is located in a receiving means 8 for insulation piercing connecting devices is inserted through the slotted opening 5 into the line chamber 4 which is equipped with the cable end 3. The axial force applied via the insulation piercing connecting device 9 first drives back the free cable end 3 and initiates or intensifies its buckling until the buckled areas of the cable end 3 completely adjoin the walls of the line chamber 4. In this state then the neutral fiber of the core of the cable end 3 is deformed such that it intersects the center line of the insulation piercing connecting device at least once in a curved shape. As soon as the free ends of the wires cannot further recede as a result of the clamping force of the clamping sleeve 6 and additionally as a result of the friction of the insulation of the cable end 3 on the walls of the line chamber, the insulation is penetrated and electrical contact is made with the insulation piercing connecting device 9. Then provisions must be made for the cable receiving part 2 to be connected to the receiving means 8 of the insulation piercing connecting devices stably and detachably or undetachably to one another. The receiving means 8 for the insulation piercing connecting devices can be for example part of the cable connector; but it is also conceivable for the insulation piercing connecting device 9 to be located on an electronic circuit board or to project out of a module, and then the receiving means 8 for the insulation piercing connecting devices would be the board or the housing of the module. The axial center line of the line chamber 4 can also be tilted obliquely to the Z-axis or Y-axis.

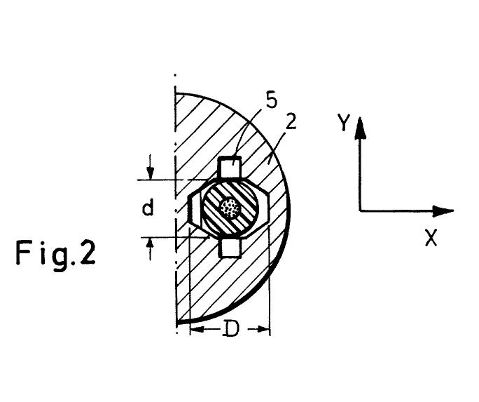

FIG. 2 shows the cable connector 1 in cross section A-A as shown in FIG. 1. In this Figure the diamond-shaped cross section of the line chamber 4 can be seen, the dimensions d and D, i.e. the extension of the diamond-shaped line chamber 4 in the X and Y direction, being different from one another. In any case it can be ensured that one of the two parameters d or D or both parameters are slightly larger than the diameter of the cable end 3 so that it can deform in the line chamber 4 in a curve shape during insertion. One especially advantageous case is when the line chamber 4 has a diamond shape and the equation d equals D is satisfied. In this way especially space-saving implementations are possible. Of course, it is also possible for the line chamber 4 to have a round, oval, square, rectangular cross section or one which represents a combination of these geometrical cross sections.

What is claimed:

1. A cable connector comprising:
a cable receiving part adapted to hold at least one cable end; and
a contact part having a connecting device adapted to secure at least one of said cable ends in said cable receiving part such that said cable end is mechanically pretensioned after connection.

2. The cable connector of claim 1, wherein said connecting device of said contact part comprises an insulation piercing connecting device.

3. The cable connector of claim 2, wherein said contact part has an electrical contact adapted for electrical connection with said cable end and said contact part is matable with said cable receiving part.

4. The cable connector of claim 2, wherein said cable receiving part has a line chamber, said line chamber having a cross section larger than a cross section of said cable end.

5. The cable connector of claim 4, wherein said line chamber tapers in an end area of said line chamber.

6. The cable connector of claim 5, wherein said line chamber tapers in a wedge-shape or arc-shape.

7. The cable connector of claim 4, wherein said line chamber has a diamond-shaped cross section.

8. The cable connector of claim 4, wherein an axial center line of said insulation piercing connecting device and an axial center line of said line chamber are flush with one another.

9. The cable connector of claim 4, wherein said cable end is held in said cable receiving part such that the cable end has at least one bend.

10. The cable connector of claim 9, wherein an axial center line of said insulation piercing connecting device and an axial center line of said chamber are not parallel to one another.

11. A cable connector comprising:
cable receiving means for holding at least one cable end; and
contact means for securing said cable end in said cable receiving means such that it is mechanically pretensioned after connection.

12. The cable connector of claim 11, wherein said contact means comprises an insulation piercing connecting device.

13. The cable connector of claim 11, wherein said contact means comprises an insulation piercing connecting device disposed in a receiving means for insulation piercing connecting devices adapted for connection to said cable receiving part.

14. The cable connector of claim 11, wherein said cable receiving means has a line chamber having a cross section larger than a cross section of said cable end.

15. The cable connector of claim 14, wherein said line chamber tapers in an end area.

16. The cable connector of claim 15, wherein said line chamber tapers in a wedge-shape or arc-shape.

17. The cable connector of claim 14, wherein an axial center line of said contact means is flush with an axial center line of said line chamber.

18. The cable connector of claim 14, wherein an axial center line of said contact means is not parallel with an axial center line of said chamber.

19. The cable connector of claim 14, wherein said line chamber has a diamond-shaped configuration.

20. The cable connector of claim 11, further comprising clamping means associated with said cable receiving means for securing a cable end.
